(19) United States
(12) Patent Application Publication
(10) Pub. No.: US 2008/0018418 A1
(43) Pub. Date: Jan. 24, 2008

(54) Built-in cross-coupled dielectric filter

(75) Inventor: Yuqing Zhao, Zhangjiagang (CN)

Correspondence Address: OLIFF & BERRIDGE, PLC, P.O. BOX 320850, ALEXANDRIA, VA, 22320-4850, US

(73) Assignee: CAIQIN ELECTRONICS ELEMENTS CO., LTD., ZHANGJIAGANG (CN)

(21) Appl. No.: 11/822,233

(22) Filed: Jul. 3, 2007

(30) Foreign Application Priority Data
Jul. 21, 2006 (CN) 200610041057.1

(51) Int. Cl. H01P 1/202

(52) U.S. Cl. 333/206

(57) ABSTRACT

A stable and reliable built-in cross-coupled dielectric filter with temperature-independent performances and improved rectangular degree and amplitude-frequency characteristic is disclosed. The built-in cross-coupled dielectric filter comprises at least three sequentially welded coaxial dielectric resonators. Mutually coupled capacitors or mutually coupled inductors are etched on the two adjacent lateral surfaces of the adjacent coaxial dielectric resonators, respectively, with an alternate setup. The input and output ports of the built-in cross-coupled dielectric filter are positioned at the two coaxial dielectric resonators at the head and tail, respectively. The present invention is particularly applicable to the high-frequency realm such as microwave.

### FIELD OF THE INVENTION

The present invention relates to a microwave device, and more particularly to a coupled dielectric filter.

### BACKGROUND OF THE INVENTION

The prior well-known separate dielectric filter is made from a coaxial dielectric resonator, adopting a low pass prototype, and based on a normalized frequency variable from a calculation and an admittance transformation. A capacitor is manufactured on an alumina ceramic substrate, a pin is installed in a hole of the coaxial dielectric resonator and connected with the capacitor, and thus a band-pass dielectric filter is obtained. It has four great shortcomings resulted from the structure of separate dielectric filter: First, the separate dielectric filter adopts an exterior dielectric coupling, which results in a poor reliability, and makes the capacitor and a terminal of the coaxial dielectric resonator easy to fall off. Second, for an increased number of levels, the ceramic-substrated capacitor will have to be lengthened, and is thus very easy to become ruptured during transportation, installation and decline, causing a poor contact. Third, temperature drift of the ceramic substrate as the capacitor substrate at high and low temperatures, due to temperature characteristics of the ceramic substrate, highly tends to result in performance deterioration of the filter. Fourth, since mutual influence of electromagnetic field between all levels of exterior coupling at high frequencies (such as frequencies above 3G) is very strong, it is very difficult to give attention to all levels of coupling, and thus difficult to produce a high-quality filter.

### Contents of the Invention

The technical goal that the present invention intends to achieve is to provide a stable and reliable filter with temperature-independent performances and improved rectangular degree and amplitude-frequency characteristic.

The technical solution of the present invention is as below in order to achieve the technical goal: A built-in cross-coupled dielectric filter is provided that comprises at least three sequentially welded coaxial dielectric resonators; mutually coupled capacitors or mutually coupled inductors are etched on the two adjacent lateral surfaces of the adjacent coaxial dielectric resonators, respectively, with an alternate setup; and the input and output ports of the built-in cross-coupled dielectric filter are positioned at the two coaxial dielectric resonators at the head and tail, respectively.

The mutually coupled capacitors are made by etching mutually-matched open-loop grooves on the two adjacent lateral surfaces of the adjacent coaxial dielectric resonators. The mutually coupled inductors are made by etching mutually-matched straight-line grooves on the two adjacent lateral surfaces of the adjacent coaxial dielectric resonators.

The open-loop groove is a rectangular groove with an open top.

The input and output ports are coated with the polytetrafluoroethylene material.

The beneficial effect of the present invention is as below: Achieving the coupling between the coaxial dielectric resonators by adopting the cross coupling between the built-in capacitors and inductors, the present invention effectively solves the reliability and stability problems at high and low temperatures, and significantly improves the rectangle degree and amplitude-frequency characteristic of the filter.

### BRIEF DESCRIPTION OF THE DRAWINGS

FIG. 1 is a schematic view of the structure principle of the present invention.

FIG. 2 is a front outside view of the present invention.

### DETAILED DESCRIPTION OF THE EMBODIMENTS

A further description of the present invention will be given below according to the drawings. However, the present invention should not be limited to this embodiment only.

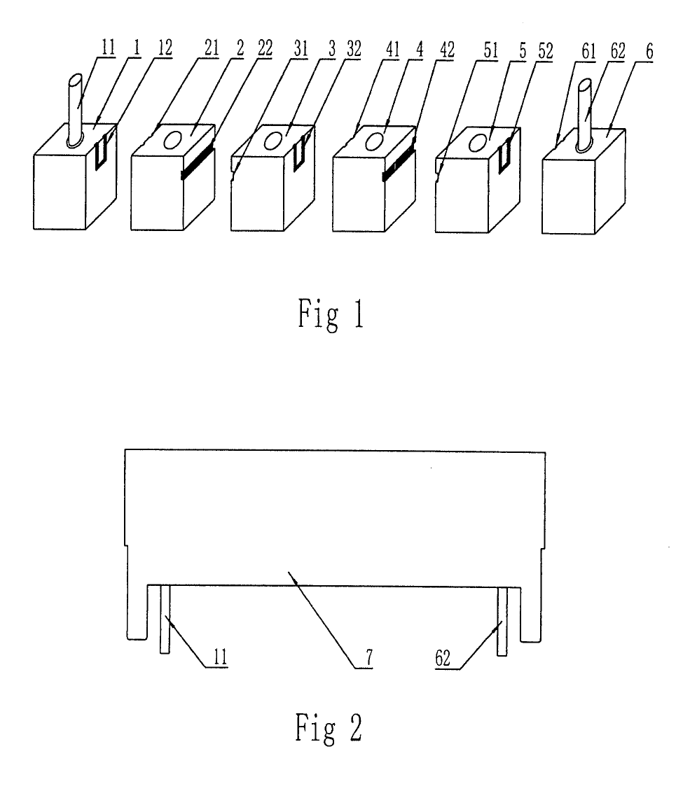

As shown in FIG. 1, the built-in cross-coupled dielectric filter in the embodiment comprises the six sequentially welded coaxial dielectric resonators, coaxial dielectric resonator 1, coaxial dielectric resonator 2, coaxial dielectric resonator 3, coaxial dielectric resonator 4, coaxial dielectric resonator 5 and coaxial dielectric resonator 6; the mutually-coupled open-top rectangular grooves 12 and 21 are etched on the adjacent lateral surfaces of the coaxial dielectric resonator 1 and the coaxial dielectric resonator 2, respectively; the mutually-coupled straight-line grooves 22 and 31 are etched on the adjacent lateral surfaces of the coaxial dielectric resonator 2 and the coaxial dielectric resonator 3, respectively; the mutually-coupled open-top rectangular grooves 32 and 41 are etched on the adjacent lateral surfaces of the coaxial dielectric resonator 3 and the coaxial dielectric resonator 4, respectively; the mutually-coupled straight-line grooves 42 and 51 are etched on the adjacent lateral surfaces of the coaxial dielectric resonator 4 and the coaxial dielectric resonator 5, respectively; the mutually-coupled open-top rectangular grooves 52 and 61 are etched on the adjacent lateral surfaces of the coaxial dielectric resonator 5 and the coaxial dielectric resonator 6, respectively; the two adjacent mutually-matched open-top rectangular grooves together constitute the coupled capacitors, with the capacitance determined by the size of the area enclosed by the open-top rectangular groove; the two adjacent mutually-matched straight-line grooves together constitute the coupled inductors, with the inductance determined by the cross-sectional area of the straight-line groove; the coaxial dielectric resonator 1 is provided with the input port 11 of the built-in cross-coupled dielectric filter, and the coaxial dielectric resonator 6 with the output port 62 of the built-in cross-coupled dielectric filter; the input port 11 and output port 62 are coated with the polytetrafluoroethylene material; during the actual manufacturing process, the size of the area enclosed by the etched open-top rectangular groove can be adjusted according to the actual capacitance requirement, and the cross-sectional area of the etched straight-line groove adjusted according to the actual inductance requirement. As shown in FIG. 2, during the actual manufacturing process, the number of the coaxial dielectric resonators can be determined according to the actual situation, and the built-in cross-coupled dielectric filter of the present invention is case-packaged by the silver-plated copper plate 7. Moreover, the open-loop groove can also be of other shapes of grooves such as a U-form one besides the open-top rectangular groove.

1. A built-in cross-coupled dielectric filter, wherein the built-in cross-coupled dielectric filter comprises at least three sequentially welded coaxial dielectric resonators; mutually coupled capacitors or mutually coupled inductors are etched on the two adjacent lateral surfaces of the adjacent coaxial dielectric resonators, respectively, with an alternate setup; and the input and output ports of the built-in cross-coupled dielectric filter are positioned at the two coaxial dielectric resonators at the head and tail, respectively.

2. The built-in cross-coupled dielectric filter according to claim 1, wherein the mutually coupled capacitors are made by etching mutually-matched open-loop grooves on the two adjacent lateral surfaces of the adjacent coaxial dielectric resonators, and the mutually coupled inductors by etching mutually-matched straight-line grooves on the two adjacent lateral surfaces of the adjacent coaxial dielectric resonators.

3. The built-in cross-coupled dielectric filter according to claim 2, wherein the open-loop groove is a rectangular groove with an open top.

4. The built-in cross-coupled dielectric filter according to claim 1, wherein the input and output ports are coated with the polytetrafluoroethylene material.

5. The built-in cross-coupled dielectric filter according to claim 2, wherein the input and output ports are coated with the polytetrafluoroethylene material.

6. The built-in cross-coupled dielectric filter according to claim 3, wherein the input and output ports are coated with the polytetrafluoroethylene material.
